(19) United States
(12) Patent Application Publication
(10) Pub. No.: US 2015/0113423 A1
(43) Pub. Date: Apr. 23, 2015

(54) SYSTEM AND METHOD TO CONFIGURE A FIELD DEVICE

(71) Applicant: YOKOGAWA ELECTRIC CORPORATION, Tokyo (JP)

(72) Inventors: Mamerto Giango, Singapore (SG); Gowtham Anne, Singapore (SG); Sin Wai Chan, Singapore (SG)

(73) Assignee: YOKOGAWA ELECTRIC CORPORATION, Tokyo (JP)

(21) Appl. No.: 14/057,645

(22) Filed: Oct. 18, 2013

(51) Int. Cl. H04L 29/08; G06F 3/0484

(52) U.S. Cl. CPC H04L 67/025; G06F 3/0484
USPC 715/740

(57) ABSTRACT

The present invention relates to a primary apparatus to configure a field device in use with a secondary apparatus. An application on the primary apparatus accesses a web application on the secondary apparatus. When a driver validator determines that a relevant driver for the field device is not on installed on the primary apparatus, the relevant driver is received from the secondary apparatus for the configuration. A corresponding system, software and method are also disclosed.

### FIELD OF INVENTION

This invention relates to a system and method to configure a field device in an industrial plant.

### BACKGROUND OF INVENTION

In a Distributed Control System for an industrial plant, there are many field devices from various vendors. For a particular function, field devices from different vendors are installed, for example pressure control valves, temperature control valves, as such. All vendors create their own software application to represent and configure a specific field device. Each field device has a unique software application, each software application has a different usability and functionality, a user has to be trained for each software application and require the experience to be familiar with using the correct software application for each field device. Thus, a lot of effort and time is required to install and identify software applications for all field devices.

Various standards—Device Description (DD), Enhanced Device Description (EDD), Field Device Tool (FDT), Field Device Integration (FDI), as such are organized to address the above problems of providing unique software application to configure each field device. The various standards share a common method of configuring a field device. This method is done by using a system software application and a field device specific driver or software component. Field device vendor provides the driver or software component to be hosted on a system software application, which is provided by system software vendors. The driver or software component, which is hosted to the system software application, is used to configure the relevant field device.

Using FDT technology as an example, it is established to standardize the communication and configuration interface between all field devices and host systems. Field device vendors create a driver, known as Device Type Manager (DTM), and system vendors create a host application, known as Frame Application, for hosting the drivers.

FIG. 1 illustrates a system in a prior art for configuring a field device 10. The field device 10 is connected to a destination apparatus 12, such as a computer. A user has to install a host application 14 and a field device driver 16 to configure the field device 10 using the destination apparatus 12. For some field devices 10, a field device driver 16 catalog has to be updated for the host application 14 to use the driver 16. After the installations are completed on the destination apparatus 12, the information of the field device 10 is shown on a User Interface 20 of the destination apparatus 12 for configuration or modification. The installations and configuration are done manually by the user for each new field device 10 on each destination apparatus 12.

A service is defined as an abstract resource that represents a capability of performing tasks that form a coherent functionality from the point of view of providers and requesters. To be used, a service must be realized by a concrete provider agent.

The services which are used for the installations and configurations are stored in a services application 18 to enable communications between the field device 10, host application 14 and field device driver 16 or driver 16 in the catalog.

In an example scenario, before the user conducts a test or configuration on a field device 10 with ten destination apparatus 12, all the ten destination apparatus 12 have to be manually configured as described above.

In yet another scenario, when there is software enhancement to the host application 14, the user has to install the software enhancement manually to each destination apparatus 12.

Since host application installations, driver installations, updating of field device driver catalog, enhancement installations and configuration are done manually, it is very tedious when there are many field devices 10 and/or many destination apparatus 12 which need to be manually modified. There is a need for improvements in this aspect.

### SUMMARY OF THE INVENTION

In a first aspect, there is provided a primary apparatus to configure a field device in an industrial plant. The primary apparatus comprises an application for accessing a secondary apparatus, the secondary apparatus including a web application having a host application and a driver validator service, a field device driver deployment service, and a relevant field device driver for configuring the field device. The primary apparatus also comprises a deployed web application received from the secondary apparatus, the deployed web application having a user interface and a driver validator service. Preferably, when the driver validator service on the primary device determines that a relevant field device driver for the field device is not in the primary apparatus, the field device driver deployment service is activated by the driver validator service on the primary apparatus to transfer the relevant field device driver from the secondary apparatus to the primary apparatus, and when the relevant field device driver is transferred to the primary apparatus, the user interface application is activated on the primary apparatus to configure a field device.

The application is preferably a browser or a shortcut to access the secondary apparatus on a network. In addition, the deployed web application may be a duplicate of the web application in the secondary apparatus. It is preferable that the deployed web application is the web application on the secondary apparatus which is accessed through the browser on the primary apparatus.

In a second aspect, there is also provided a secondary apparatus to configure a field device in an industrial plant on a primary apparatus. The secondary apparatus comprises a host application; a web application for deploying to the primary apparatus, the web application having a host application and a driver validator service; a relevant field device driver; and a field device driver deployment service for transferring the relevant field device driver from the secondary apparatus to the primary apparatus to configure the field device.

In a third aspect, a system to configure a field device using the primary apparatus and the secondary apparatus is also provided.

In a final aspect, there is provided a computer-implemented method to configure at least one field device in an industrial plant on a primary apparatus. The method comprises accessing a first application on a secondary apparatus, the first application having a host application and a driver validator service; determining whether a relevant field device driver for the at least one field device is in the primary apparatus; transferring and installing the field device driver from the secondary apparatus to the primary apparatus when the relevant field device driver is not in the primary apparatus; and activating a user interface to configure the at least one field device.

Preferably, the first application is accessed from the primary apparatus using either a browser or a shortcut to the browser for accessing the secondary apparatus on a network. In addition, the method may further include identifying the at least one field device for configuration.

### DESCRIPTION OF THE FIGURES

In order that the present invention may be fully understood and readily put into practical effect, there shall now be described by way of non-limitative example only preferred embodiments of the present invention, the description being with reference to the accompanying illustrative figures.

FIG. 1 is an illustration of the prior art.

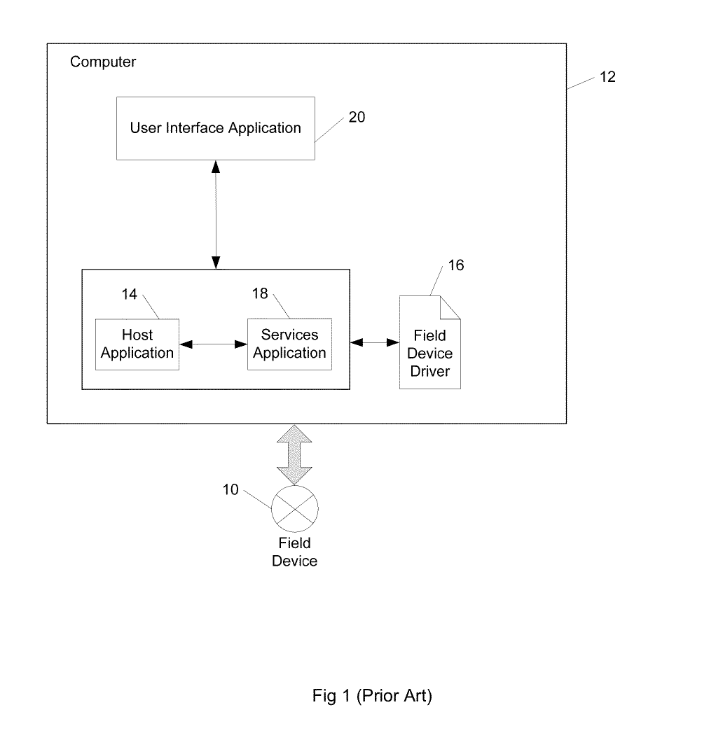

FIG. 2 is a process flow of the present invention.

FIG. 3 is block diagram of the present invention.

FIG. 4 is an example of a table in a field device driver catalog.

### DETAILED DESCRIPTION OF THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill of the art that the present invention may be practiced without these specific details. In other instances, well known methods, procedures, components, and features have not been described in detail as not to unnecessarily obscure aspects of the present invention.

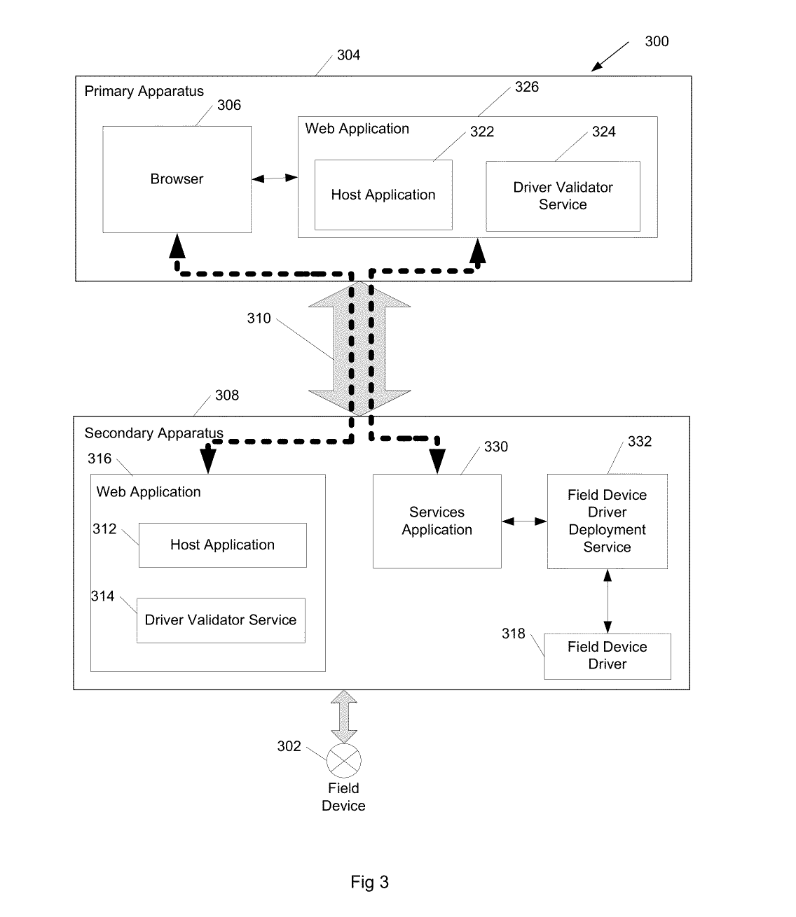

Referring to FIG. 3, there is provided a system 300 to configure a field device 302 in a Distributed Control System (“DCS”) of an industrial plant using a primary apparatus 304. The field device 302 can be connected to the secondary apparatus 308 by a network 310. The network 310 can be a physical connection which is wireless or wired, for example Ethernet, USB, and so forth. The network 310 can be either public or private.

The primary apparatus 304 is able to configure, test and/or monitor the field device 302. Examples of the primary apparatus 304 include, for example, personal computer, server, tablet, handheld apparatus, any such apparatus which includes a processer, display and an input means (including a touchscreen display) and so forth. Further, the primary apparatus 304 has an application 306 for accessing the secondary apparatus 308. Preferably, the application 306 is a browser which can be activated automatically on startup or by a user. The browser 306 can be any of Internet Explorer, Chrome, Firefox, Safari, as such.

The primary apparatus 304 is in communication with a secondary apparatus 308 through the network 310. The secondary apparatus 308 can be, for example, a personal computer, server, any such apparatus which has at least a processor, storage for storing at least a field device driver 318, a web application 316 and a host application, in the form of a User Interface for configuring the field device 302.

Web Application can be represented as a hierarchy of directories and files (unpacked form) or a file reflecting the same hierarchy (packed form). Web Application is a deployable package which contains:
Web components. A Web component is defined as a server-side object used by a Web-based client (browsers) to interact with host applications.
Static resource files such as images
Helper classes
Libraries
Deployment descriptor (.xml file)

The web application 316 includes the host application 312 and a driver validator service 314. The driver validator service 314 determines if the relevant device driver 318 for the field device 302 is available on the apparatus which the driver validator is located. In this case, it is the secondary apparatus 308. The determination is done by searching a field device driver 318 catalog or database.

The user uses the browser 306 on primary apparatus 304 to access the web application 316 on the secondary apparatus 308 using a uniform resource locator, abbreviated URL, also known as web address, through the network 310. A duplicate of the web application 316 is deployed to the primary apparatus 304 as deployed web application 326. If the deployed web application 326 is already in the primary apparatus 204, the browser 306 will activate the deployed web application 326.

When the web application 326 is deployed on the primary apparatus 304, the driver validator service 314 on the secondary apparatus 308 is deployed as driver validator service 324. The driver validator service 324 determines if the relevant device driver 318 for the field device 302 is available on the primary apparatus 304. The host application 322 is automatically activated as a User Interface 322 on the primary apparatus 304 to configure the field device 302. This improves efficiency of configuring the field device 302 by reducing the effort of the user to manually install the relevant field device driver 318 and host application 322 and then to manually activate the host application 322 as a User Interface to configure the field device.

The field device driver 318 is required to configure the field device 302 and can be in the format of a Device Description (“DD”), Device Type Manager (“DTM”), Field Device Integration (“FDI”) Device Package, as such. The field device driver 318 is stored in memory storage of the secondary apparatus 308. In some cases the field device driver 318 has multiple components. For such cases, the field device driver 318 is referred to as a field device driver package. The determination is based on each component which is required for the configuration of the field device 302. The availability of all the required components is determined by the web application 326. Usually, there are multiple field device drivers 318, each for a type of field device 302, since an industrial plant has multiple types of field devices 302. The field device drivers 318 are stored in a database and a field device driver 318 catalog lists the available field device drivers 318 for the various field devices 302.

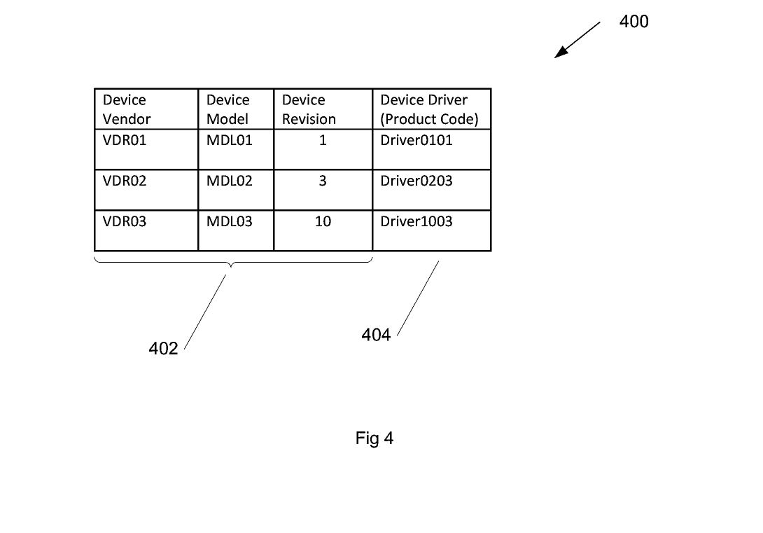

FIG. 4 illustrates an example of a lookup table 400 in the field device driver 318 catalog. Column 402 is a listing of type identifiers for field devices 302, examples of type identifiers are manufacturer, model and revision. Column 404 is the corresponding field device driver 318.

The secondary apparatus 308 includes a services application 330 which stores services used for installation, configuration and modification of the field device 302. The services are to enable communication among the field device 302, the primary apparatus 304, the secondary apparatus 308 and any other components in the primary apparatus 304 and the secondary apparatus 308.

A field device driver deployment service 332 enables the relevant field device drive 318 to be transferred to the primary apparatus 304 automatically when necessary. The advantage is when the User Interface 322 is activated, the user can proceed with the configuration thus saving time and effort to transfer the field device driver 318 manually.

Other services provided by the service application 330 include an authentication service. The authentication service checks if the user who is logged in on the primary apparatus 304 is allowed to access the service application 330. The checking is done by comparing the logged in user with a list of users who have access.

Another service is a device communication service which enables sending and receiving messages between the User Interface 322 and the service application 320. A session manager service is provided to manage the primary apparatus 304 connection with the service application 320.

The services application 320 is in communication with the primary apparatus 304 and its components using the network 310.

A plurality of browsers 306 can be provided on the primary apparatus 304, where each browser is used to configure a different field device. Alternatively, the browser can have a plurality of tabs, each tab for configuring a different field device. Advantageously, several field devices can be configured simultaneously.

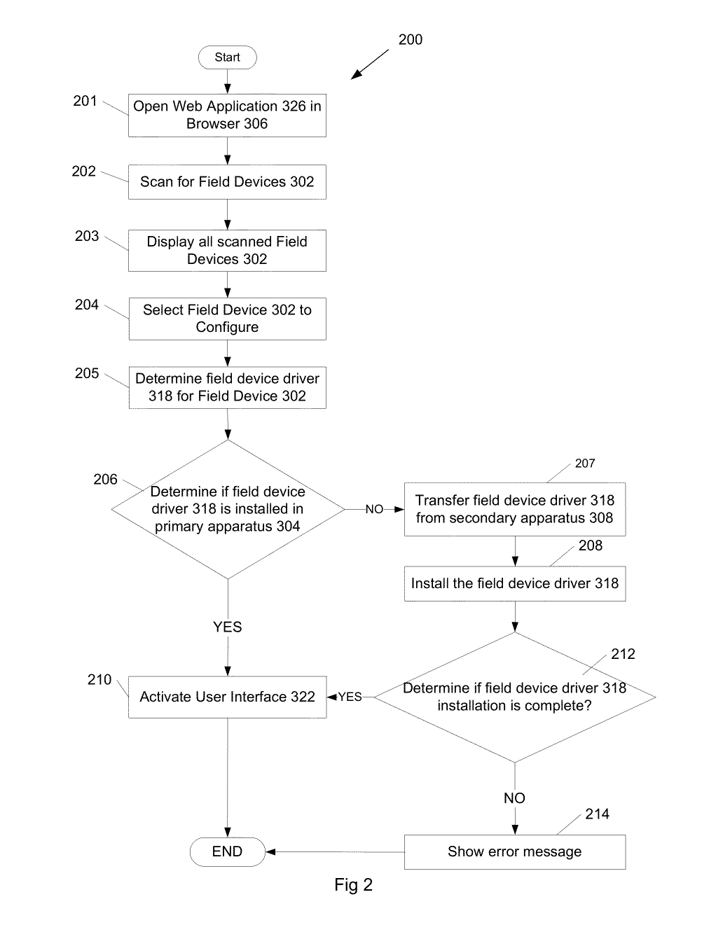

Referring to FIG. 2, there is provided a computer-implemented method 200 in the system 300 to configure the field device 302 using the primary apparatus 304. In Step 201, a user activates the browser 306 on the primary apparatus 304.

In step 202, the field device(s) 302 are scanned by the secondary apparatus 308. The identification can be done for an online mode or an offline mode. In an online mode, the primary apparatus 304, secondary apparatus 308 and field device(s) 302 are connected to the network 310. In an offline mode, the primary apparatus 304 and secondary apparatus 308 are connected to the network 310, the field device(s) 302 are not connected to the network 310 and a database of field device(s) 302 is available for access by the secondary apparatus 308. The database of field device(s) can be on primary apparatus 304, secondary apparatus 308 or any other external storage accessible on the network 310.

For the online mode, the scanning is done in the network 310 to identify the field device(s) 302. For the offline mode, the scanning is done in the database.

A listing of the scanned field device(s) 302 is provided in Step 203. In step 204, the user is able to select the desired field device(s) 302 for configuration.

In Step 205, services in the services application 330 enable the deployed web application 326 in the primary apparatus 304 to communicate with the secondary apparatus 308 to determine the field device driver 318 which is required for configuration of the field device 302. The determination is based on each component which is required for the configuration of the field device 302. The availability of all the required components is determined by the web application 326.

Alternatively, Step 205 identifies a relevant field device driver 318 for the field device 302 from the field device driver 318 catalog. The identification may be done by matching with the field device driver 318 for configuring the selected field device 302. The identification can be done by using the lookup table 400 which lists the field device driver 318 corresponding or relevant to the field device 302 by type identifiers 402.

Step 206 is carried out by the driver validator service 324 in the primary apparatus 304 to determine if the identified relevant field device driver 318 is installed on the primary apparatus 304.

If the identified relevant field device driver 318 is not installed on the primary apparatus 304, a copy of the field device driver 318 is transferred from the secondary apparatus 308 to the primary apparatus 304 as shown in Step 207. After the transfer, Step 208 installs the transferred field device driver 318 in the primary apparatus 304. Step 209 determines whether the installation of the transferred field device driver 318 has been carried out successfully. Advantageously, the user does not have to locate the requisite field device driver 318 and carry out the field device driver 318 installation manually. If the installation of the transferred field device driver 318 has been deemed to be unsuccessful, the process ends with an error message to the user. Such an error message can be stating the error and/or identifying the source of the error.

Step 210 automatically activates and displays user interface 322 to configure the selected field device 302. The User Interface 322 is displayed when the relevant field device driver 318 is determined to be already installed in the primary apparatus 304.

When the user wants to configure multiple field devices 302 on the primary apparatus 304 at the same time, one User Interface 322 is provided for each field device 302. Each User Interface 322 may be provided on a separate browser window or separate tabs on one browser window.

Using the present invention to configure a field device 302, there is no need to install multiple host applications 322 or a database of field device drivers 318. Only the relevant field device driver 318 is transferred automatically to the primary apparatus 304 for installation. This reduces the requirement of data storage on the primary apparatus 304. Thus, any mobile apparatus such as a tablet or handheld apparatus is suitable for use as a primary apparatus 304. This increases the user convenience for field device configuration/ monitoring which can be done at any location, remotely or locally.

Further, when the host application 322 carries out processing on the secondary apparatus 308, the primary apparatus 304 can operate with a lower processing capability. This allows for flexibility in choosing the type of primary apparatus 304.

1. A primary apparatus to configure a field device in an industrial plant, the primary apparatus comprising:
an application for accessing a secondary apparatus, the secondary apparatus including
a web application having a host application and a driver validator service,
a field device driver deployment service, and
a relevant field device driver for configuring the field device;
a deployed web application received from the secondary apparatus, the deployed web application having a user interface and a driver validator service;
wherein when the driver validator service on the primary device determines that a relevant field device driver for the field device is not in the primary apparatus, the field device driver deployment service is activated by the driver validator service on the primary apparatus to transfer the relevant field device driver from the secondary apparatus to the primary apparatus, and
when the relevant field device driver is transferred to the primary apparatus, the user interface application is activated on the primary apparatus to configure a field device.

2. The apparatus as claimed in claim 1 wherein the application is a browser or a shortcut to access the secondary apparatus on a network.

3. The apparatus as claimed in claim 1 wherein the deployed web application is a duplicate of the web application in the secondary apparatus.

4. The apparatus as claimed in claim 2 wherein the deployed web application is the web application on the secondary apparatus which is accessed through the browser on the primary apparatus.

5. A secondary apparatus to configure a field device in an industrial plant on a primary apparatus, the secondary apparatus comprising
a host application;
a web application for deploying to the primary apparatus, the web application having a host application and a driver validator service;
a relevant field device driver; and
a field device driver deployment service for transferring the relevant field device driver from the secondary apparatus to the primary apparatus to configure the field device.

6. A system to configure a field device using the primary apparatus of claim 1, with the secondary apparatus of claim 5.

7. A computer-implemented method to configure at least one field device in an industrial plant on a primary apparatus comprising
accessing a first application on a secondary apparatus, the first application having a host application and a driver validator service;
determining whether a relevant field device driver for the at least one field device is in the primary apparatus;
transferring and installing the field device driver from the secondary apparatus to the primary apparatus when the relevant field device driver is not in the primary apparatus; and
activating a user interface to configure the at least one field device.

8. The method as claimed in claim 7 wherein the first application is accessed from the primary apparatus using either a browser or a shortcut to the browser for accessing the secondary apparatus on a network.

9. The method as claimed in claim 7 further includes identifying the at least one field device for configuration.
